(19) United States
(12) Patent Application Publication
(10) Pub. No.: US 2023/0032991 A1
(43) Pub. Date: Feb. 2, 2023

(54) AIRDROP DEVICE USED WITH UNMANNED AERIAL VEHICLE

(71) Applicant: Suzhou Dahanghai Innovation & Technology Co., Ltd., Suzhou City (CN)

(72) Inventor: Yiheng Gu, Shanghai City (CN)

(21) Appl. No.: 17/515,367

(22) Filed: Oct. 29, 2021

(30) Foreign Application Priority Data
Aug. 2, 2021 (CN) 202121785051.1

(51) Int. Cl. B64D 1/08; B64C 39/02

(52) U.S. Cl. CPC B64D 1/08; B64C 39/024; B64C 2201/128

(57) ABSTRACT

The present disclosure belongs to the technical field of unmanned aerial vehicles, and specifically relates to an airdrop device used with an unmanned aerial vehicle. The airdrop device includes a clamping jaw bearing block, a control panel, a power supply, a power source, and a photosensitive sensor. The clamping jaw bearing block is used to be detachably connected with an unmanned aerial vehicle; the control panel, the power supply, the power source, and the photosensitive sensor are all mounted on the clamping jaw bearing block; and the output end of the power source is provided with an engine arm used to hang a material bag. The power supply, the power source, and the photosensitive sensor are all connected with the control panel; and the control panel receives a light signal detected by the photosensitive sensor and controls the power source to act. The airdrop device used with the unmanned aerial vehicle of the present disclosure has a simple and reasonable structure. The clamping claw bearing block is detachably connected to the unmanned aerial vehicle, and the material bag is hung on the engine arm. When materials need to be thrown in air, light below the fuselage of the unmanned aerial vehicle is turned on, and the control panel receives the light signal detected by the photosensitive sensor and controls the power source to act so that the engine arm rotates to detach the material bag.

### TECHNICAL FIELD

The present disclosure belongs to the technical field of unmanned aerial vehicles, and specifically relates to an airdrop device used with an unmanned aerial vehicle.

### BACKGROUND

With the continuous deepening of the research on unmanned driving technologies today, there is a huge extension room for applications of unmanned aerial vehicles. When personnel and materials are difficult to send, materials, i.e., water, food, small emergency equipment, simple medical drugs, and other domestic and medical articles, can be thrown in the air to achieve emergency support.

At present, unmanned aerial vehicle airdrop devices used in China are all designed on the basis of large-sized unmanned aerial vehicles, so they are not convenient to use to transport materials for residents on high floors. The use of some small-sized unmanned aerial vehicle products on the market as high-altitude material transportation tools also has great limitations. The limitations are embodied in the following aspects: I. The fuselage of the small-sized unmanned aerial vehicle does not have a good structure for fixing materials. II. If the materials are tied to the fuselage of the small-sized unmanned aerial vehicle, the materials cannot be automatically landed.

### SUMMARY

The present disclosure provides an airdrop device used with an unmanned aerial vehicle, which solves the technical problem of limitation of an unmanned aerial vehicle of the existing art used for transporting materials for residues on high floors.

The present disclosure is realized by the following technical solution:

An airdrop device used with an unmanned aerial vehicle includes a clamping jaw bearing block, a control panel, a power supply, a power source, and a photosensitive sensor. The clamping jaw bearing block is used to be detachably connected with an unmanned aerial vehicle; the control panel, the power supply, the power source, and the photosensitive sensor are all mounted on the clamping jaw bearing block; and the output end of the power source is provided with an engine arm used to hang a material bag.

The power supply, the power source, and the photosensitive sensor are all connected with the control panel; and the control panel receives a light signal detected by the photosensitive sensor and controls the power source to act.

Further, the clamping jaw bearing block has two groups of clamping jaws; and the clamping jaw bearing block is clamped to the unmanned aerial vehicle through the two groups of clamping jaws.

Further, a first frame and a second frame are respectively formed on the left side and the right side of the clamping jaw bearing block; the control panel is located in the first frame; and the power supply is located in the second frame.

Further, a partition plate is arranged in the middle of the clamping jaw bearing block; two ends of the partition plate are respectively connected with the two groups of clamping jaws; the photosensitive sensor is mounted above the partition plate; and the power source is mounted below the partition plate.

Further, a switch is further arranged between the power supply and the control panel.

Further, the engine arm includes a long arm and a short arm; the long arm and the short arm are perpendicularly connected so that the engine arm is crossed; and the material bag is hung on the long arm and is limited and blocked by the short arm.

Further, the power source is a steering engine.

Further, the power supply is a rechargeable power supply.

Further, the clamping jaw bearing block is of a 3D printing integrated structure.

Further, the clamping jaw bearing block is a structural member made of a polylactic acid (PLA) material.

Based on the above technical solution, the present disclosure has the technical effects:

The airdrop device used with the unmanned aerial vehicle of the present disclosure has a simple and reasonable structure. The clamping claw bearing block is detachably connected to the unmanned aerial vehicle, and the material bag is hung on the engine arm. When it is necessary to throw materials in air, light below the fuselage of the unmanned aerial vehicle is turned on, and the control panel receives the light signal detected by the photosensitive sensor and controls the power source to act so that the engine arm rotates to detach the material bag.

The preferable technical solutions of the present disclosure further have the following technical effects:

The power supply is the rechargeable power supply independent of the unmanned aerial vehicle, which avoids use of the power of the unmanned aerial vehicle to drop the materials and ensures the working time of the unmanned aerial vehicle. At low power, the rechargeable power supply can be charged.

The clamping jaw bearing block is made of the PLA material via 3D printing integration and has the advantage of light weight, so as to prevent an overload of the unmanned aerial vehicle. Meanwhile, the unmanned aerial vehicle with a fixed loading capacity can carry more materials.

### BRIEF DESCRIPTION OF THE DRAWINGS

In order to describe the embodiments of the present disclosure or the technical solutions in the existing art more clearly, drawings required to be used in the embodiments or the illustration of the existing art will be briefly introduced below. Obviously, the drawings in the illustration below are only some embodiments of the present disclosure. Those ordinarily skilled in the art also can acquire other drawings according to the provided drawings without doing creative work.

FIG. 1 is a schematic structural diagram of an airdrop device used with an unmanned aerial vehicle according to the embodiments; and

FIG. 2 is a schematic structural diagram of an airdrop device used with an unmanned aerial vehicle according to the embodiments from another view.

In the drawings:
1: clamping jaw bearing block; 101: clamping jaw; 102: first frame; 103: second frame; 104: partition plate;
2: control panel;
3: power supply;
4: power source;
5: photosensitive sensor;
6: engine arm; 601: long arm; 602: short arm;
7: switch.

### DETAILED DESCRIPTION OF THE EMBODIMENTS

In order to make the objectives, technical solutions, and advantages of the implementation modes of the present disclosure clearer, the technical solutions in the implementation modes of the present disclosure will be described clearly and completely below in combination with the drawings in the implementation modes of the present disclosure. Apparently, the implementation modes described are part of the implementation modes of the present disclosure, not all the implementation modes. Based on the implementation modes in the present disclosure, all other implementation modes obtained by those of ordinary skill in the art without creative work shall fall within the protection scope of the present disclosure. Therefore, the following detailed description for the implementation modes of the present disclosure provided in the accompanying drawings is not intended to limit the scope of the claimed present disclosure, but merely represents selected implementation modes of the present disclosure. Based on the implementation modes in the present disclosure, all other implementation modes obtained by those of ordinary skill in the art without creative work shall fall within the protection scope of the present disclosure.

In the description of the present disclosure, it should be understood that orientations or positional relationships indicated by the terms “center”, “longitudinal”, “transverse”, “length” “width”, “thickness”, “upper”, “lower”, “front”, “rear”, “left”, “right”, “vertical”, “horizontal”, “top”, “bottom”, “inside”, “outside”, “clockwise”, “anticlockwise”, and the like are orientations or positional relationships as shown in the drawings, and are only for the purpose of facilitating and simplifying the description of the present invention instead of indicating or implying that equipment or elements indicated must have particular orientations, and be constructed and operated in the particular orientations, so that these terms are not construed as limiting the present disclosure.

In addition, the terms “first” and “second” are only for the purpose of description, and may not be understood as indicating or implying the relative importance or impliedly indicating the number of technical features indicated. Therefore, features defined by “first” and “second” can explicitly instruct or impliedly include one or more features. In the description of the present disclosure, unless expressly specified otherwise, the meaning of the “plurality” is two or more than two.

In the present disclosure, unless otherwise clearly specified and defined, the terms “mounted”, “connected”, “coupled”, “fixed”, and the like should be understood in a broad sense, for example, it can be a fixed connection, a detachable connection, or integrated. It can be a mechanical connection or an electrical connection. It can be a direct connection, or an indirect connection through an intermediate medium. It can also be an internal connection between two components or the interaction between two components. For those of ordinary skill in the art, the specific meanings of the above terms in the present disclosure can be understood according to specific situations.

In the present disclosure, unless otherwise clearly defined and defined, the first feature being “above” or “under” the second feature may include that the first and second features are in direct contact, or may include that the first and second features are not in direct contact but in contact through other features between them. Moreover, the first feature being “on”, “at the upper side of” and “on the upper surface of” the second feature includes that the first feature is right above and at the oblique upper side of the second feature, or only indicates that the horizontal height of the first feature is greater than that of the second feature. the first feature being “below”, “at the lower side of” and “on the lower surface of” the second feature includes that the first feature is right below and at the oblique lower side of the second feature, or only indicates that the horizontal height of the first feature is less than that of the second feature.

### EMBODIMENTS

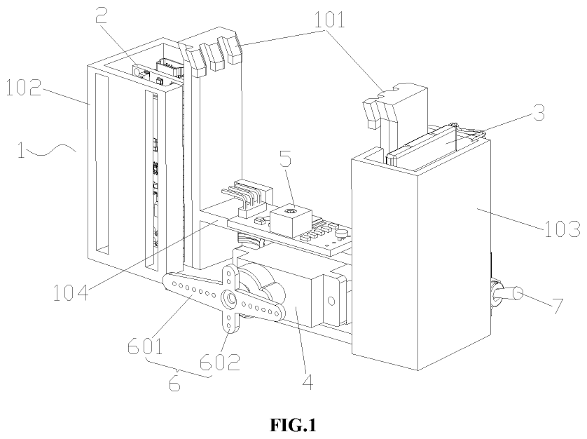

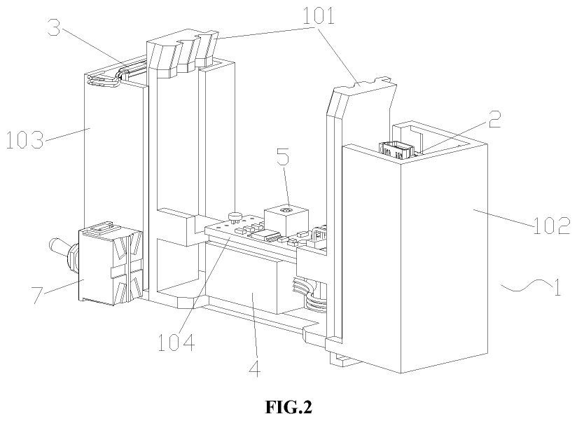

As shown in FIG. 1 and FIG. 2, the present embodiment provides an airdrop device used with an unmanned aerial vehicle, including a clamping jaw bearing block 1, a control panel 2, a power supply 3, a power source 4, and a photosensitive sensor 5. The clamping jaw bearing block 1 is used to be detachably connected with an unmanned aerial vehicle; the control panel 2, the power supply 3, the power source 4, and the photosensitive sensor 5 are all mounted on the clamping jaw bearing block 1; and the output end of the power source 4 is provided with an engine arm 6 used to hang a material bag.

The power supply 3, the power source 4, and the photosensitive sensor 5 are all connected with the control panel 2. In the present embodiment, the control panel 2 is preferably a NANO panel. The power source 4 is preferably a steering engine. The control panel 2 receives a light signal detected by the photosensitive sensor 5 and controls the power source 4 to act.

Specifically, in the present embodiment, the clamping jaw bearing block 1 is made of a polylactic acid material and is integrated via a 3D printing technology. The upper part of the clamping jaw bearing block 1 has two groups of clamping jaws 101 corresponding to heat dissipation openings in two sides of the unmanned aerial vehicle. During mounting, the clamping jaws 101 are clamped to the heat dissipation openings of the unmanned aerial vehicle and elastically clamp the unmanned aerial vehicle by use of the elasticity of a 3D printing material.

In the present embodiment, a first frame 102 and a second frame 103 are respectively formed in the left side and the right side of the clamping jaw bearing block 1. The control panel 2 is located in the first frame 102, and the power supply 3 is located in the second frame 103, so as to play a role of fixing and protecting the control panel 2 and the power supply 3.

As a further improvement of the present embodiment, the power supply 3 is a rechargeable power supply, preferably a lithium battery pack. The bottom of the second frame 103 is provided with a charging port convenient for charging the power supply 3.

In the present embodiment, a partition plate 104 is arranged in the middle of the clamping jaw bearing block 1; two ends of the partition plate 104 are respectively connected with the two groups of clamping jaws 101; the photosensitive sensor 5 is mounted above the partition plate 104 and corresponds to a lamp of the unmanned aerial vehicle; and the power source 4 is mounted below the partition plate 104.

As a further improvement of the present embodiment, a switch 7 is further arranged between the power supply 3 and the control panel 2. As a preferable selection, the switch 7 is a toggle switch used to control the control panel 2 to be powered on and powered off.

As a further improvement of the present embodiment, the engine arm 6 includes a long arm 601 and a short arm 602; the long arm 601 and the short arm 602 are perpendicularly connected so that the engine arm 6 is crossed; and the material bag is hung on the long arm 601 and is limited and blocked by the short arm 602.

Based on the above technical solution, during specific sue of the present disclosure:

Firstly, the clamping jaw bearing block 1 is clamped below the unmanned aerial vehicle through the clamping jaws 101 so that the whole airdrop device will not shake in the unmanned aerial vehicle flying and material hanging process. Then, the toggle switch 7 is shifted, and the power supply 3 is turned on to supply power to the control panel 2, the steering engine, and the photosensitive sensor 5. When materials need to be hung on the unmanned aerial vehicle, the long arm of the engine arm 6 is in a vertical state, the material bag is hung on the long arm 601 of the engine arm 6, and the short arm 602 plays a role of blocking and limiting the material bag. When the unmanned aerial vehicle is ready to throw the materials in the air, the light below the unmanned aerial vehicle is controlled to be turned on. The light irradiates the photosensitive sensor 5, and the control panel 2 receives the light signal detected by the photosensitive sensor 5 and controls the steering engine to act, thus driving the engine arm 6 to rotate. The vertical long arm 601 rotates to be downwards inclined, and the hung materials slide off with the gravity.

The above descriptions are only specific implementation modes of the present disclosure, but the protection scope of the present disclosure is not limited to this. Any person skilled in the art can easily think of changes or replacements within the technical scope disclosed by the present disclosure. The changes or replacements should be covered by the protection scope of the present disclosure.

What is claimed is:

1. An airdrop device used with an unmanned aerial vehicle, comprising a clamping jaw bearing block (1), a control panel (2), a power supply (3), a power source (4), and a photosensitive sensor (5), wherein the clamping jaw bearing block (1) is used to be detachably connected with an unmanned aerial vehicle; the control panel (2), the power supply (3), the power source (4), and the photosensitive sensor (5) are all mounted on the clamping jaw bearing block (1); the output end of the power source (4) is provided with an engine arm (6) used to hang a material bag;
the power supply (3), the power source (4), and the photosensitive sensor (5) are all connected with the control panel (2); and the control panel (2) receives a light signal detected by the photosensitive sensor (5) and controls the power source (4) to act.

2. The airdrop device used with an unmanned aerial vehicle according to claim 1, wherein the clamping jaw bearing block (1) has two groups of clamping jaws (101); and the clamping jaw bearing block (1) is clamped to the unmanned aerial vehicle through the two groups of clamping jaws (101).

3. The airdrop device used with an unmanned aerial vehicle according to claim 2, wherein a first frame (102) and a second frame (103) are respectively formed on the left side and the right side of the clamping jaw bearing block (1); the control panel (2) is located in the first frame (102); and the power supply (3) is located in the second frame (103).

4. The airdrop device used with an unmanned aerial vehicle according to claim 3, wherein a partition plate (104) is arranged in the middle of the clamping jaw bearing block (1); two ends of the partition plate (104) are respectively connected with the two groups of clamping jaws (101); the photosensitive sensor (5) is mounted above the partition plate (104); and the power source (4) is mounted below the partition plate (104).

5. The airdrop device used with an unmanned aerial vehicle according to claim 1, wherein a switch (7) is further arranged between the power supply (3) and the control panel (2).

6. The airdrop device used with an unmanned aerial vehicle according to claim 1, wherein the engine arm (6) comprises a long arm (601) and a short arm (602); the long arm (601) and the short arm (602) are perpendicularly connected so that the engine arm (6) is crossed; and the material bag is hung on the long arm (601) and is limited and blocked by the short arm (602).

7. The airdrop device used with an unmanned aerial vehicle according to claim 1, wherein the power source (4) is a steering engine.

8. The airdrop device used with an unmanned aerial vehicle according to claim 1, wherein the power supply (3) is a rechargeable power supply.

9. The airdrop device used with an unmanned aerial vehicle according to claim 1, wherein the clamping jaw bearing block (1) is of a 3D printing integrated structure.

10. The airdrop device used with an unmanned aerial vehicle according to claim 9, wherein the clamping jaw bearing block (1) is a structural member made of a polylactic acid (PLA) material.
